(19) United States
(12) Patent Application Publication
(10) Pub. No.: US 2009/0138187 A1
(43) Pub. Date: May 28, 2009

(54) Method and device for the automatic generation of traffic management strategies

(76) Inventor: Paul Mathias, Aachen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/990,675

(22) PCT Filed: Aug. 1, 2006
(86) PCT No.: PCT/EP2006/064890

§ 371 Date: Feb. 19, 2008

(30) Foreign Application Priority Data
Aug. 30, 2005 (DE) 10 2005 041 066.9

(51) Int. Cl. G08G 1/01

(52) U.S. Cl. 701/117

(57) ABSTRACT

There is described a method and a device for automatically generating traffic management strategies in the event of suddenly occurring traffic events that lead to a disruption in the flow of traffic. During the method, a database is used in which information concerning elements of the influencing of traffic and control of traffic, which exist in the traffic network, local positions of the elements, switching states that can be adopted by the elements, and immediate effects of the respective switching states upon the traffic is contained in a form that can be processed by a computer program. Based on the incoming data concerning the traffic events or disruptions in the flow of traffic as well as an actual traffic situation, a simulation is automatically carried out with an analysis program, during which dynamics of the spread of the disruption in the traffic network are modeled and one or more new traffic-optimal route allocations with capacity values required therefore are calculated. A generation program selects from the database the elements that can make a contribution to the conversion of the new route allocation, and automatically parameterizes these elements using the adoptable switching states and their effect. The selected elements and their parameterization are suggested to an operator as a strategy. The method and the associated device make possible a quick reaction to unforeseeable events in the traffic network.

### CROSS REFERENCE TO RELATED APPLICATIONS

This application is the US National Stage of International Application No. PCT/EP2006/064890, filed Aug. 1, 2006 and claims the benefit thereof. The International Application claims the benefits of German application No. 10 2005 041 066.9 DE filed Aug. 30, 2005, both of the applications are incorporated by reference herein in their entirety.

### FIELD OF INVENTION

The present invention relates to a method and device for the automatic generation of traffic management strategies in the event of suddenly occurring traffic events in a traffic network, which can lead to traffic disruption.

### BACKGROUND OF INVENTION

Until now strategic traffic management to ensure a smooth flow of traffic in a traffic network has related solely to the handling of predictable, traffic-related events or situations. To this end possible events are analyzed or simulated in an offline planning process, corresponding measures are defined and the effect of said measures estimated, in some instances using simulation tools. The workings steps of defining and evaluating the measures are run through a number of times in some circumstances, to achieve an acceptable solution by way of an incremental improvement. The sum of the measures, which are defined in this planning process as a response to the trigger event or situation, is referred to as a strategy. The strategies designed using such planning processes are stored in a database together with the events or situations, to which they relate.

In operational mode, currently occurring events are compared with the stored situations and the measures of the stored strategy stored for a corresponding situation are activated. This is generally done by an operator but can also be done with the aid of tools, which automatically identify current situations on the basis of incoming data and compare them with stored situations.

With such a procedure however unpredicted or unexpected events are a problem, as they have not already been planned for beforehand. Until now there has been little or no assistance for the operator for such situations. Decisions about the measures to be instituted have to be taken heuristically using the knowledge and experience of the operator. The simultaneous occurrence of a number of events or disruptions, taking place in spatial proximity and therefore interacting with each other in such a manner that the stored strategies associated with the individual events can no longer be applied in an unrestricted manner, is similarly problematic. Combining strategies which are optimal for the individual event can even be counter-productive in such cases.

### SUMMARY OF INVENTION

An object of the present invention is to specify a method and a device, which in the event of suddenly occurring, unpredictable events automatically provide a strategy for traffic management in the affected traffic network.

The object is achieved with the method and device as claimed in independent claims. Advantageous refinements of the method and device are set out in the subclaims or will emerge from the description which follows and the exemplary embodiments.

With the present method a database is provided, in which information about the elements present in the traffic network that influence and control traffic, local positions of elements in the traffic network, which can be located there, switching states that can be adopted by the elements and the immediate effects of the respective switching states on the traffic are contained in a form that can be processed by a computer program. The switching states here refer to the states of the respective element that can be set by actuating the elements, which have a traffic-influencing or traffic-controlling effect on the traffic, in particular on the route selection of road users.

When an unexpected event occurs, which results in traffic disruption, a simulation is automatically carried out using an analysis program based on incoming data relating to traffic events or disruptions and a current traffic situation, in which simulation dynamics of the spread of disruption in the traffic network are modeled as the impact of the traffic events or traffic disruptions. The analysis program then uses the modeled dynamics and a resulting route allocation to calculate one or more new route allocations that are better, preferably optimal, in respect of traffic, with the capacities of the individual route segments required for them. In this process the calculation or simulation takes place in the known manner on the basis of a suitable network model.

Once this/these new route allocation(s) has/have been predetermined, a generation program selects from the database the elements influencing and controlling traffic that can contribute to the achievement of the new route allocation(s) and automatically parameterizes all or some of the selected elements based on the switching states they can adopt and their effect to control the new route allocation(s). In this process selection can be based in particular on local positions and the capacity values that can be achieved with the elements. The generation program then displays the selected elements and their parameterization to an operator after they have been combined to form a set of measures in the form of a strategy. The operator can verify the plausibility of this strategy, accept it, reject it or modify it. Naturally a number of strategies can also be offered to the operator for selection, if a number of favorable or optimal strategies result from the previous process. The entire process takes place immediately after the data relating to the corresponding traffic event or disruption is input, so that the operator can respond quickly to the changed situation.

With the present method and associated device therefore individual measures are collated online and automatically and proposed to the operator as a specific strategy as a response to currently detected situations or disruptions in operational traffic management. The measures of such a strategy generally do not exist beforehand but are designed automatically as an immediate response to the event. Ideally the operator can check the plausibility of the set of measures and then activate in real time.

The associated device correspondingly comprises the database, in which information about elements present in the traffic network that influence and control traffic, local positions of at least some of the elements in the traffic network, switching states that can be adopted by the elements and immediate effects of the respective switching states on the traffic is contained in a structured form that can be processed by a computer program. The device also comprises an analysis and optimization module, which uses an analysis program to carry out an automatic analysis encompassing the traffic network based on incoming data relating to traffic events or disruptions and a current traffic situation, in which analysis effects of the traffic events or disruptions are simulated and dynamics of the spread of disruption in the traffic network are modeled and in which analysis one or more new route allocations that are better in respect of traffic, as well as capacity values required for them, are calculated based on the modeled dynamics and a route allocation resulting therefrom. A generation module is also provided, which automatically selects from the database, using the information contained therein and based on the new route allocation(s) and associated capacity values, the elements influencing and controlling traffic that can contribute to the implementation of the new route allocation(s) and parameterizes the selected elements based on the switching states they can adopt and their effect for the implementation of the new route allocation(s). The generation module then displays the measures thus generated, i.e. the selected elements and their parameterization, to an operator as a strategy.

Important features of the present invention consist of the provision of a database, which contains all the elements controlling and influencing traffic with their spatial location and their switching states and their effects in a systematic, structured form, so that these elements can be further processed, in particular selected and parameterized, by a computer program. This database therefore contains no strategies, just information about elementary measures, in other words individual control options, which can be implemented using the elements present in the traffic network. Suitable coding of the information stored in the database, in particular in respect of the effects of the different switching states of the elements, allows the elementary measures required for optimal route allocation to be derived by the generation program. An elementary measure here corresponds to the switching of one of the elements to a switching state that can be adopted by said element. The previous simulation for modeling the dynamics of the spread of disruption and for finding a new, optimal route allocation preferably takes place on the basis of the identical network model for the entire traffic network.

### BRIEF DESCRIPTION OF THE DRAWINGS

The present method and associated device are described briefly again below with reference to exemplary embodiments in conjunction with the drawings, in which:

FIG. 1 shows a schematic diagram of an example of the method sequence for the present method and for the associated device; and

FIG. 2 shows an example of the coded form, in which the information about a light signal system can be present in the database.

### DETAILED DESCRIPTION OF INVENTION

The present method utilizes the fact that the effect of the elementary measures on the traffic can be expressed by three parameters:

the capacity of a route segment, in other words a street segment between two node points (junctions), which can be controlled for example by light signal systems;

route allocation, which can be influenced for example by vehicle navigation systems or electronic information boards; and

the traffic load, which can be influenced for example by radio announcements or road use charges.

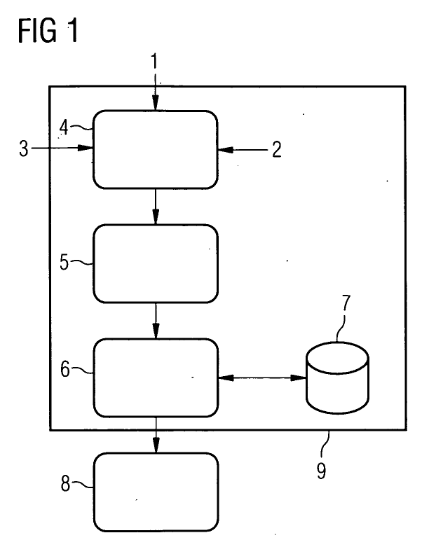

The method is essentially made up of two method components. An analysis part serves to estimate the effects of events and disruption taking into account the currently activated control and influencing measures in the traffic network. To this end data 1 relating to the unexpectedly occurring event or the traffic disruption, data 2 relating to the current traffic situation in the traffic network and data 3 relating to the current control states of the elements influencing and controlling traffic in the traffic network is supplied to the analysis part 4 of the analysis and optimization module of the device 9, as shown in FIG. 1. In the analysis part 4 a network-wide macroscopic simulation is carried out, which realistically models the dynamics of the spread of disruption, which in particular include known tailback phenomena, taking into account all relevant, currently activated control parameters in the process.

In the measures part of the present method in a first step the modeled dynamics and associated route allocations and capacity values are used to calculate new optimal route allocations and their associated capacity values, which serve as a theoretical default for possible measures. This takes place in the optimization part 5 of the analysis and optimization module.

Methods such as those described in DE 19858477 B4 or in P. Matthias, “Statische und dynamische Verkehrsumlegung mit Rekurrenten Neuronalen Netzen” (Static and dynamic traffic rerouting with recurrent neural networks), Shaker Verlag (ISBN 3-8265-6720-X), Herzogenrath, 1999 for example can be used for analysis and optimization.

In a second step the database 7 is accessed and in the generation module 6 all the elementary measures are identified which can contribute to the implementation of the theoretical defaults, in other words the change of route allocation and capacity values from the present state to the new state. In this process the local positions of the respective elements and the effects that can be achieved with the elements play a particular role. The elementary measures thus selected are automatically parameterized on the basis of the effect analysis. In this process the capacity value required for the corresponding route allocation is generally compared with the capacity values that can be achieved with the different switching states of the selected elements. The most suitable switching state in each instance for the required capacity is hereby selected. Selection and parameterization of the elements can also take place in an iterative process, in which a simulation is carried out after each iteration step, to check the degree of correspondence with the required route allocation and the required capacity values. All the parameterized elementary measures are then combined to form a strategy and presented to the operator on a monitor 8.

The elements of the traffic system stored in the database 7 can for example be traffic controlling elements in the form for example of light signal systems, variable message signs, relating for example to variable lane allocation, systems for displaying a variable speed restriction or traffic influencing elements in the form of information boards, elements for relaying traffic information to media or vehicle navigation systems or variable signposting systems. Locally variable elements can also be included in the database, for example measures such as police roadblocks.

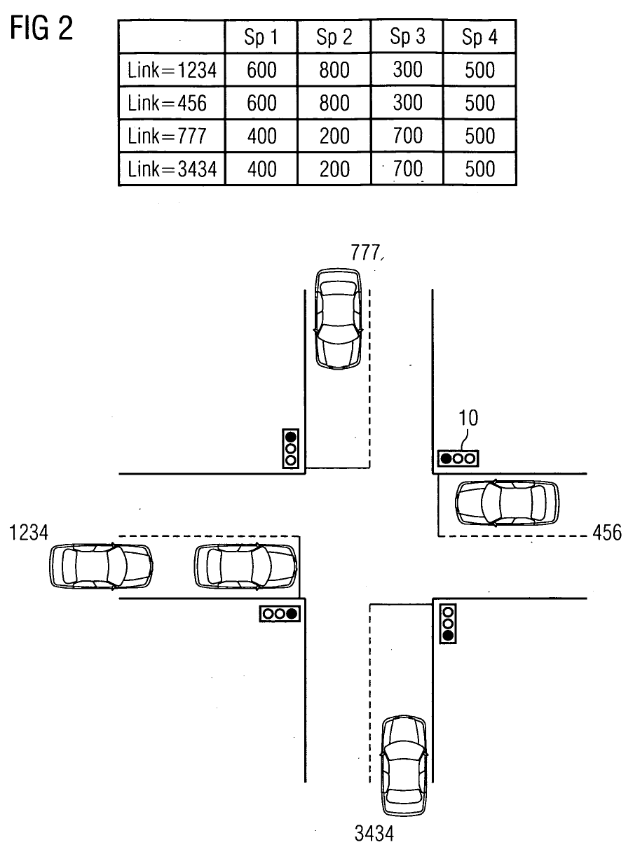

The information relating to the elements must be stored in the database in a suitably coded manner, so that the generation program can find, parameterize and analyze the effects of the appropriate elements. The top part of FIG. 2 shows an example of such a coding of a traffic control element based on a light signal system 10, as shown in the bottom part of the figure. Stored with the light signal systems are the associated signaling programs, which contain characteristic green time allocations, as well as their effects on the capacities of the approaches to the junction, at which the light signal system 10 is arranged.

In this example the information is structured in the form of a matrix, in which the columns correspond to the different signaling programs SP1 to SP4 of the light signal system 10 and the rows correspond to the different links, in other words route or street segments (1234, 777, 456, 3434), for which the capacity value shown in the matrix applies. A capacity value here indicates the number of vehicles per hour, which can pass along the associated route segment when the corresponding signal program is activated. Thus for example by activating the signal program SP2 on route segments (1234) and (456) it is possible to achieve a capacity of 800 vehicles per hour. The local position of the light signal system can be derived from the information relating to the route segments converging at this point.

Naturally the signaling programs can also contain differing levels of a public passenger transport prioritization system. When parameterizing light signal systems it should be noted that only certain general parameters (framework plans) can generally be specified. Specific implementation is effected using the traffic-dependent control methods at the respective junction or centrally by parameterizing network wide (adaptive control methods). The basic parameters can also include information relating to preferred coordinations.

With the present method and associated device it is for example also possible in the event of disruption to identify automatically those information boards, which are in the approach region and tailback region of the disruption. Since the re-allocation of the route pattern due to the disruption is known, warnings or diversion recommendations in text form can be generated as individual measures of the proposed strategy. Such automatically composed texts can also be forwarded to media.

In the event of disruption due to an accident, the present method and associated device can also be used to forward corresponding information to public passenger transport companies automatically, with precise details of the lines affected, possible alternative routes, etc. If the switching options of the public passenger transport system are also known, further information can be generated, for example a cycle change, line allocation, etc. Likewise it is possible to inform the police of the junctions or streets that are most suitable for manual blocks or diversions.

1.-8. (canceled)

9. A method for an automatic generation of traffic management strategies in the event of traffic events or traffic disruption in a traffic network, comprising:
providing a database, in which information about
elements present in the traffic network that influence and control traffic,
local positions of at least some of the elements,
switching states that can be adopted by the elements, and
immediate effects of respective switching states on the traffic is contained to be processed by a program;
automatically analyzing the traffic network using an analysis program,
wherein the analyze is based upon incoming data relating to traffic events or disruptions and a current traffic situation,
wherein effects of the traffic events or traffic disruptions are simulated,
wherein dynamics of a spread of disruption in the traffic network are modeled, and
wherein based upon the modeled dynamics one or more new route allocations, that are better in respect of traffic, are calculated along with associated capacity values; and
providing a generation program automatically selecting from the database, using the information contained therein and based on the new route allocation and associated capacity values, the elements influencing and controlling traffic, wherein the selected elements contribute to the implementation of the new route allocation,
parameterizing the selected elements based upon
switching states they can adopt, and
their effect for the implementation of the new route allocation;
displaying the selected elements and their parameterization to an operator.

10. The method as claimed in claim 9, wherein the database comprises locally variable measures with their immediate effect on the traffic as elements influencing and controlling traffic.

11. The method as claimed in claim 9, wherein at least a plurality of elements influencing and controlling traffic are selected from the group consisting of a light signal system, a controllable information board, a variable message sign, a variable speed restriction, and a combination thereof.

12. The method as claimed in claim 9, wherein capacity values for a traffic flow are specified as immediate effects of the respective switching states on the traffic for at least some of the elements influencing and controlling traffic.

13. The method as claimed in claim 9, wherein at least one selected element is controlled based upon a signaling program, wherein the signaling program has differing levels of a public passenger transport prioritization system.

14. The method as claimed in claim 9, wherein a police is informed of junctions or streets that are most suitable for manual blocks.

15. The method as claimed in claim 9, wherein a police is informed of junctions or streets that are most suitable for diversions.

16. A device for an automatic generation of traffic management strategies in a traffic network in the event of traffic events or traffic disruption, comprising:
a database, in which information about
elements present in the traffic network that influence and control traffic,
local positions of at least some of the elements,
switching states that can be adopted by the elements, and
immediate effects of respective switching states on the traffic are stored;
an analysis and optimization module automatically analyzing the traffic network,
wherein the analyze is based upon incoming data relating to traffic events or disruptions and a current traffic situation,
wherein effects of the traffic events or traffic disruptions are simulated,
wherein dynamics of a spread of disruption in the traffic network are modeled, and
wherein based upon the modeled dynamics one or more new route allocations, that are better in respect of traffic, are calculated along with associated capacity values;
a generation program to automatically select from the database, using the information contained therein and based on the new route allocation and associated capacity values, the elements influencing and controlling traffic, wherein the selected elements contribute to the implementation of the new route allocation, wherein the selected elements are parameterized based upon switching states they can adopt, and their effect for the implementation of the new route allocation; and
a display device for displaying the selected elements and their parameterization to an operator.

17. The device as claimed in claim 16, wherein the database comprises locally variable measures with their immediate effect on the traffic, which are similarly selected, parameterized and displayed to the operator as part of the strategy by the generation program, where suitable.

18. The device as claimed in claim 16, wherein the database comprises light signal systems and controllable information boards and variable message signs and variable speed restrictions as elements influencing and controlling traffic.

19. The device as claimed in claim 17, wherein the database comprises light signal systems and controllable information boards and variable message signs and variable speed restrictions as elements influencing and controlling traffic.

20. The device as claimed in claim 16, wherein capacity values for traffic flow are specified as immediate effects of the respective switching states on the traffic for at least some of the elements influencing and controlling traffic.
